(19) United States
(12) Patent Application Publication
(10) Pub. No.: US 2004/0168045 A1
(43) Pub. Date: Aug. 26, 2004

(54) Out-of-order processor executing speculative-load instructions

(76) Inventors: Dale Morris, Steamboat Springs, CO (US); Matthew Howard Reilly, Stow, MA (US)

Correspondence Address: HEWLETT-PACKARD COMPANY, Intellectual Property Administration, P.O. Box 272400, Fort Collins, CO, 80527-2400, US

(21) Appl. No.: 10/371,870

(22) Filed: Feb. 21, 2003

(51) Int. Cl. G06F 9/00

(52) U.S. Cl. 712/225

(57) ABSTRACT

In addition to speculatively executing normal (non-speculative) load instructions in advance of their program order, an out-of-order processor executes the speculative (advanced) load instructions originally compiled for in-order processors. Both the speculative-load instructions and the corresponding check instructions can be executed out-of-order. The speculative-load instructions are treated like normal-load instructions while in the instruction queue. When a speculative-load instruction is retired from the instruction queue, it is transferred to a speculative load instruction manager. Execution of the corresponding check instruction can then check the validity of the speculative-load instruction.

### BACKGROUND OF THE INVENTION

The present invention relates to data processors and, more particularly, to data processors that employ speculative loads. A major objective of the invention is to provide a high-performance out-of-order processor that is compatible with programs employing speculative-load instructions such as those used in some in-order processors.

Much of modern progress is associated with advances in computer technology. In turn, much of the increased functionality and performance in computers is related to advances in semiconductor manufacturing technology. However, within any generation of manufacturing technology, there is still a need to optimize performance. Such optimization is often achieved through processor design advances such as instruction pipelining and parallel processing.

Speculative processing is a more recent design strategy in which instructions are executed in advance of their logical order in a program and before the validity of the result can be ensured. The advanced execution permits results to be available for other instructions earlier than they would be if the instructions were executed in the logical order. On the other hand, the out-of-order execution can result in speculation failures that must be corrected, e.g., by resuming an earlier state and re-executing the instruction.

Load instructions and conditional-branch instructions are suitable candidates for speculative execution. Load instructions, which transfer data from external memory to local registers, can be quite time-consuming, and, thus, delay execution of subsequent instructions that depend on the loaded data. Conditional-branch instructions often call subroutines that need to be completed before a main program sequence can be continued. Early execution of the load and conditional-branch instructions can minimize or eliminate the delay before subsequent dependent instructions begin execution.

The advanced execution of conditional branch instructions is speculative when it occurs before it is known that the branch would have been taken if the program instructions were executed in order. The advanced execution of a load instruction can be speculative when it is possible that the contents of the requested memory location could change between the time the load instruction is executed and when it was supposed to be executed from a program logic standpoint. For example, when a load is advanced in front of a store instruction that accesses the same external memory location, the load instruction transfers the wrong data to the target register.

Needless to say, a data processor that implements speculative execution must have a way to handle speculation failures. In general, a processor that executes speculatively maintains a state history so that, when a speculation fails, an earlier non-speculative state can be restored. In the case of speculative loads, there are two very different approaches (“hardware” vs. “software”) with two different methods of implementing speculation and recovering from speculation failures.

An “out-of-order” processor implements the hardware approach to speculative loads when a load instruction is executed speculatively in advance of other instructions that precede it in the program order. Such a processor has an “instruction queue” that holds many instructions at a time. Instructions enter the queue in program order and typically exit (“retire from”) the queue in program order. However, instructions in the queue are all “available” for execution in or out of order.

In an out-of-order processor, load instructions tend to be executed early in the queue, while store instructions tend to be executed late, e.g., as they are retired from the queue. Thus, a load instruction is likely to be executed before a store instruction that closely precedes it in a program sequence. When the load instruction is executed, it is not removed from the queue, but remains in the queue. In addition, the external memory address accessed by the load instruction (typically in a compressed form) is associated with the executed load instruction in the queue.

When a store instruction is executed (e.g., as it retires from the queue) the external memory address (or a compressed version thereof) to which it transfers data is broadcast throughout the queue. If the store address matches any load address in the queue, the previously executed load is treated as invalid; the load instruction is then marked unexecuted (“data-ready”) and is subsequently re-executed (e.g., either immediately or upon retirement). As long as the valid speculations outnumber failed speculations sufficiently, such out-of-order processing can achieve significant performance gains.

The advantages of speculative loading are not restricted to out-of-order processors. More conventional “in-order” processors can take advantage of speculative loading by including in their instruction sets special “speculative-load” instructions. Hereinafter, speculative-load instructions are referred to as “s-load instructions”, in contrast to normal non-speculative instructions, which are referred to as “n-load instructions”. These s-load instructions would typically be introduced when a high-level program is compiled into machine-level code. The compiler would look for n-load instructions and, where appropriate, would replace them with s-loads earlier in the program sequence. Typically, “check” instructions are inserted closer to the point at which an n-load would have been inserted. The check instruction checks for speculation failure and, in the case of a failure, instigates a reload or branches to a recovery routine.

An in-order processor that executes s-load instructions typically keeps track (e.g., in an s-load table) of such loads until they are validated by a check instruction or are re-executed at a time where they are not speculative. When stores are executed, the associated address is broadcast through the s-load table; s-load instructions with matching addresses are marked invalid. The check instruction checks the validity of the associated s-load instruction. If it is still valid, it can be retired from the table; otherwise, appropriate corrective action is taken.

Both the hardware and software approaches to speculative loading can be considered improvements over processors that execute only non-speculative loads in order. Out-of-order processors are designed to improve the performance of non-speculative programs designed for in-order processors, while in-order processors that can handle speculative instructions can also execute programs without speculative instructions as efficiently as in-order processors that do not handle speculative instructions. Further gains in in-order performance can be achieved by recompiling a program without speculative loads into one that takes advantage of speculative loads. In many cases, programs can be recompiled to take better advantage of out-of-order processors as well.

Generally, programs compiled to take advantage of one processor's special features may not be run optimally or even be compatible with other processors. For example, a program optimized for an out-of-order processor might not run optimally on an in order processor that uses speculative loads. Furthermore, a compiled program optimized for a speculative in-order processor may not even be compatible with an out-of-order processor. However, users consider it a burden to install recompiled versions of their software every time they upgrade a computer's processor or migrate to another computer. What is needed is an approach to implementing speculative loads that minimizes compatibility problems and while, preferably, optimizing performance.

### SUMMARY OF THE INVENTION

The present invention provides an out-of-order data processor that executes, not only n-load instructions, but also s-load instructions and the check instructions used to check the validity of the s-load instructions. Note that the presence of an associated check instruction is the essential characteristic distinguishing an s-load instruction from an n-load instruction. Typically, however, a load instruction can be classified as either an s-load instruction or an n-load instruction based on the form of the instruction itself. Preferably, the processor transfers data as called for by an s-load instruction and uses the check instruction to check the validity of the s-loads as appropriate.

The data processor can include an instruction handler that holds instructions available for execution and an instruction manager that determines the actual order of execution. More specifically, the data processor can include an instruction queue through which all program instructions proceed, and a queue manager that determines the order in which instructions in the queue are executed. The data processor can also include an s-load-instruction manager (SLIM) that stores valid s-load instructions that are valid when retired from the queue, but subject to additional confirmation in accordance with the associated check instruction; optionally, the SLIM may also hold other load instructions.

The data processor can execute n-load instructions out of order; preferably, it can also execute s-load instructions out of order. Preferably, the invention provides for out-of-order execution of check instructions as well. In a preferred embodiment, s-load instructions are treated just like n-load instructions while in the queue. However, if an n-load instruction retires valid from the queue, the validation is final, while an s-load instruction that retires valid from the queue can still be invalidated while managed by the SLIM. In this preferred embodiment, check instructions cannot be executed (are not “data ready”) if the associated s-load instruction is still in the queue. Alternatively, check instructions can be executed out of order even while the associated s-load instruction is in the queue; also, the invention provides for not executing check instructions out of order-in which case they can be executed at retirement.

The validity of an n-load instruction can be affected by store instructions that are ahead of it in the queue but executed later (or, in a parallel processor environment, concurrently). Such stores can also affect the validity of an s-load instruction; in addition, stores between the s-load instruction and the corresponding check instruction in the program order can affect the validity of the s-load instruction. Accordingly, each time a store instruction is executed, the accessed memory address (or a compressed version thereof) is broadcast to the queue manager and the SLIM. In the event the store accesses the same memory location as a subsequent (in the program order) but previously executed load instruction, the result of that load instruction is considered invalid.

The status of an invalid n-load instruction can be changed from “executed” to “data-ready”; the n-load instruction is later re-executed. If the instruction is an s-load instruction in the SLIM, it is marked invalid; this will cause a branch to a recovery routine when the corresponding check instruction is executed. Depending on the embodiment, the invention provides that s-load instructions in the queue can be: marked invalid and not executed again; or “data ready” in anticipation of re-execution. Since re-executing a load instruction is likely to be less time consuming than branching to a recovery routine, the former approach is preferred.

A major advantage of the invention is that it provides an out-of-order processor that is compatible with programs compiled for a speculative in-order processor. Where the s-loads are handled, as they would be in a speculative in-order processor, there is the potential for performance gains beyond that which can be achieved by hardware speculation alone. In the course of the invention, it was determined that the hardware and software approaches to speculative loading provide advantages in different circumstances—so combining the two approaches is not completely redundant. Combining the two approaches potentially offers performance gains over either approach taken alone.

However, potential performance gains could be offset if the two approaches are not modified to cooperate effectively with each other. In particular, there is a challenge of coordinating the tasks of the queue manager and the SLIM. The present invention provides for simplifying the interaction between the queue manager and the SLIM by using the SLIM to manage only load instructions that have been retired from the queue. The queue manager handles the unretired s-load instructions. Thus, the invention provides a processor that is compatible with non-speculative in-order processors, speculative in-order processor, and non-speculative out of order processors, while achieving performance superior to those prior approaches. These and other features and advantages of the invention are apparent from the description below with reference to the following drawing.

### BRIEF DESCRIPTION OF THE DRAWING

FIG. 1 is a schematic block diagram of a computer system including a memory and a data processor in accordance with the present invention.

### DETAILED DESCRIPTION

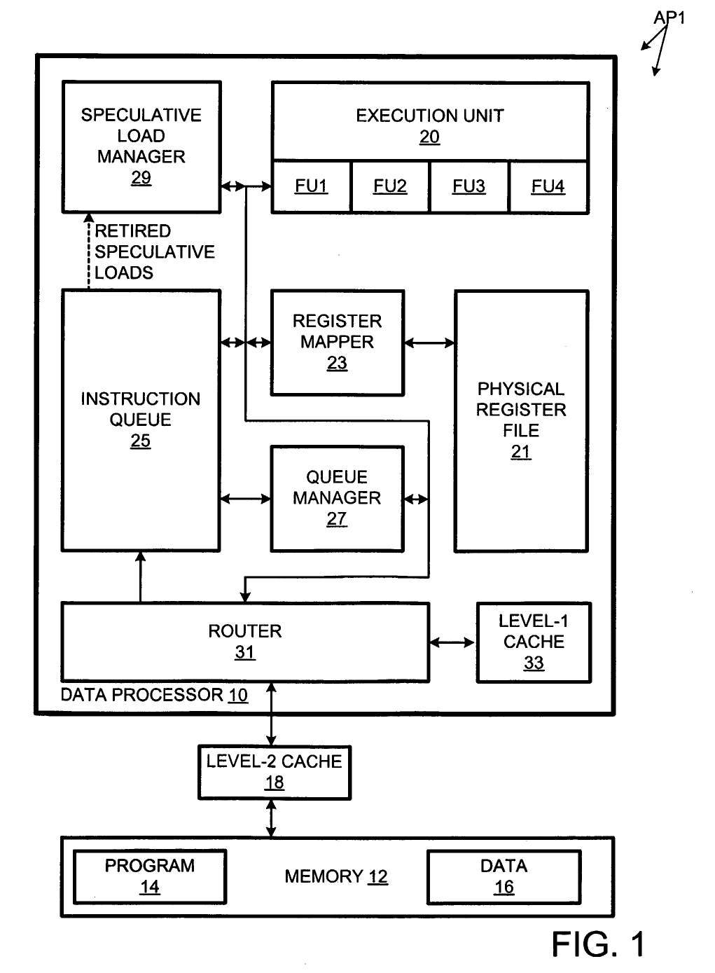

A computer system AP1 comprises an out-of-order speculative data processor 10 and memory 12, as shown in FIG. 1. Memory 12 holds data 14 and program instructions 16 at addressable external (to processor 10) memory locations. A level-2 cache 18 holds copies of the contents of recently accessed memory to speed memory accesses. Processor 10 includes an execution unit 20, a register file 21, a register mapper 23, an instruction queue 25, a queue manager 27, a speculative-load-instruction manager (SLIM) 29, a router 31, and a level-1 cache 33.

Instructions of program 16 to be executed are loaded in program order into instruction queue 25, which is 128 instructions deep. After execution, instructions are retired in program order from queue 25. Instructions are executed while in queue 25. For each instruction in queue 25, queue manager 27 determines when it is to be executed and what functional unit FU1-FU4 of execution unit 20 is to execute it.

In the illustrated embodiment, s-load instructions and n-load instructions are treated identically while in the queue. Consider a segment of program 14 in which a load (either n-load or s-load) instruction immediately follows a store instruction. The store instruction enters queue 25 before the load instruction. However, queue manager 27 schedules the load instruction for execution as soon as it is “data ready”, whereas the store instruction is not executed until retirement. An instruction is normally considered “data ready” when the queue manager determines that the contents of the registers referred to in the instruction cannot be changed by instructions that precede it in queue 25. Assuming the load instruction is data-ready well before it reaches retirement, it is executed before the store instruction.

The load instruction indirectly specifies the memory address to be read from by explicitly specifying a register containing that address. Obviously (and since the n-load instruction is data-ready before it is executed) the memory address is known at the time of execution. After execution, the load instruction maintains its order position in the queue, but it is marked “executed” and a syndrome calculated based on the memory address is associated with the executed load instruction in the queue.

Data processor 10 treats the registers specified by instructions as “virtual” registers to be mapped to physical registers of file 21 by register mapper 23. In the illustrated embodiment, there are thirty-two virtual registers that can be specified by an instruction. These are mapped to 128 physical registers. The excess of physical registers is required to allow recovery of previous states in the event of a failed speculation or an exception. Whenever an instruction calls for writing to a virtual register, register mapper 23 assigns (or reassigns) the virtual register to an unused physical register as the instruction enters queue 25. If there are no unused physical registers, the instruction is withheld from queue 25 until a physical register is available. If the virtual register was previously assigned to a different physical register, the value in that physical register is preserved. In the event of an exception, recovery can be achieved simply by reverting to previous register mappings—there is no overwritten register data to be reloaded.

When the store instruction approaches retirement, the executed load instruction remains behind it in queue 25. When the store instruction is executed, a syndrome of the memory address to which the store instruction writes is broadcast to queue manager 27 and SLIM 29. Matching executed load instructions in the queue are marked “data ready” (instead of “executed”). If other instructions depending on the load instructions have been executed out of order, queue manager 27 must recover a state that is not dependent on the failed load speculation. The store instruction is retired from queue 25.

If the load instruction under consideration is invalidated and reset to “data ready”, it is executed again before retirement. Note that, in view of the recent execution of the invalidating store instruction, it is likely the load value can be found in the level-1 cache; the reloading latency is thus likely to be minimal. In the illustrated embodiment, an s-load (like an n-load) instruction is always valid upon retirement from queue 25. (In other embodiments, s-load instructions can be invalid when retired from the queue some or even all of the time.)

What happens next depends on whether the retiring instruction is an s-load instruction or an n-load instruction. The validity of an n-load instruction upon retirement is “final”, while the validity of an s-load instruction upon retirement is “provisional”. Accordingly, n-load instructions effectively drop from consideration upon retirement, while s-load instructions are transferred to SLIM 29 for further consideration.

A retired s-load instruction enters SLIM 29 valid. (Other embodiments permit invalid s-loads to enter a SLIM.) If its syndrome subsequently matches that broadcast by a store instruction, it is marked invalid. However, as it is no longer in the queue, it cannot be re-executed.

The corresponding check instruction can enter queue 25 either while the s-load instruction is still in queue 25 or after it has been transferred to SLIM 29. In the illustrated embodiment, a check instruction is not considered data ready until the corresponding s-load instruction is retired from queue 25 and has been transferred to SLIM 29. (Other embodiments provide for executing check instructions while the corresponding s-load is still in queue 25.) Thus, when the check instruction is executed, the corresponding s-load instruction is in SLIM 29.

If execution of the check instruction determines that the corresponding s-load instruction in SLIM 29 has been rendered invalid (by an intervening store instruction), data processor 10 branches to a routine design to correct for the erroneous speculation. SLIM 29 can then discard the s-load instruction. When a check instruction is executed at retirement, a determination that the corresponding s-load instruction is valid is final in that it cannot be invalidated by a subsequently executed store instruction. Thus, whether it is validated or not, an s-load instruction is retired from SLIM 29 when the corresponding check instruction is retired from queue 25.

If the check is executed out of order and the corresponding s-load is determined to be valid, it may still be possible for an intervening store instruction to invalidate the s-load instruction. Accordingly, if there is a store ahead of the check instruction when the latter is executed, queue manager 27 schedules the check instruction for re-execution once there are no more store instructions ahead of it in queue 25. To this end, all store instructions and check instructions are assigned serial numbers (STORE_IDs) when they are fetched. Queue manager 27 can compare the STORE_ID of check instructions with the STORE-IDs of any store instruction in the queue to determine when a check instruction can be executed for the final time. If there are no stores ahead of the check instruction when it is first executed, it is not re-executed.

The invention provides for a range of alternatives to the illustrated embodiment. S-load instructions need not be treated the same as n-load instructions while in the queue. In a “degenerate” embodiment, when an s-load is executed, no load is actually performed; the memory address is still assigned to the instruction.

The corresponding check instruction is executed at retirement and always results in the conditional branch being taken (as if the corresponding s-load instruction had been invalidated).

In some other embodiments, s-load instructions are executed only in-order (upon retirement) on the theory that the compiler has already optimized the timing of their execution. The preferred embodiment, however, recognizes, that the queue manager has information affecting the timing of execution that was unavailable to the compiler. In some embodiments, s-load instructions that are invalidated in the queue are not re-executed. Instead the corresponding check causes a branch to be taken and the s-load instruction is dropped from further consideration.

In some embodiments, check instructions are always executed at retirement. In some of these embodiments, check instructions are only executed in order. This simplifies management of check instructions, but sacrifices some opportunities to begin recovery from failed s-loads early. The invention further provides for out-of-order execution of store instructions.

A SLIM can receive invalid s-load instructions and n-load instructions as well as valid s-load instructions. In fact, the invention provides for instruction sets in which the only distinction between an n-load instruction and an s-load instruction is the presence of a corresponding check instruction in the case of the latter.

The invention provides for speculative out-of-order processors that execute s-load and associated check instructions. In addition, the invention provides for non-speculative out-of-order processors that execute advanced load and associated check instructions. For example, an n-load instruction can be advanced only so far as it can be without risking being invalidated (e.g., by store instruction or an exception). Such processors have application for 3-D rendering programs where the delays due to invalidated load instructions could be unacceptable.

The invention provides for executing an advanced load instruction by treating it much as a no-op could be treated. In such embodiments, such transcoding or filtering constitutes the execution of the advanced load or check instructions. For example, the s-load instruction could actually be sent to an execution unit. Alternatively, it can be bypassed in a queue, or filtered so that it never enters a queue. Moreover, it can be removed (e.g., from an I-cache) by a micro-code transcoder—which might also transcode the associated check instruction into an unconditional branch instruction. In such embodiments, “instruction handler” denotes whatever mechanism performs the transcoding or filtering.

The invention also provides for processors in which there is no queue in the narrow sense of the term. More specifically, instructions need not enter and retire from an instruction handler in program order; in such embodiments, the entity determining execution order is referred to more generally as an “instruction manager”. These and other variations upon and modifications to the present invention are provided for by the present invention, the scope of which is defined by the following claims.

What is claimed is:

1. A data processor for executing instructions:
an instruction handler for holding a series of said instructions for execution;
an instruction manager for determining an order for executing the instructions in said instruction handler, said instruction manager providing for out-of-order execution of said instructions; and
an execution unit for executing said instructions, said execution unit providing for execution of a speculative-load instruction and an associated subsequent check instruction that determines whether or not said speculative-load instruction has failed.

2. A data processor as recited in claim 1 further comprising a speculative-load manager, said speculative-load manager storing information associated with a said speculative-load instruction between the time it is retired from said instruction handler and the execution of said check instruction.

3. A data processor as recited in claim 2 wherein said execution unit, when executing said check instruction
before said speculative-load instruction has been retired from said instruction handler, determines whether or not said speculative-load instruction has failed using information stored in said instruction handler, and
after said speculative-load instruction has been retired from said instruction handler, determines whether or not said speculative-load instruction has failed using information stored by said speculative-load manager.

4. A data processor as recited in claim 1 wherein said execution unit executes a check instruction only after the corresponding speculative-load instruction has retired from said instruction handler.

5. A data processor as recited in claim 1 wherein said execution unit sometimes executes a check instruction while the corresponding speculative-load instruction is in said instruction handler.

6. A data processor as recited in claim 2 wherein said instruction manager provides for out-of-order execution of said speculative-load instruction.

7. A data processor as recited in claim 1 wherein said instruction manager provides for out-of-order execution of said check instruction.

8. A method of executing a computer program of instructions, each of said instructions having an associated program order, defining an instruction order, said instructions including an advanced-load instruction and an associated check instruction, said method comprising:
executing said advanced-load instruction in advance of its program order; and
subsequently executing said check instruction.

9. A method as recited in claim 8 wherein said step of executing said advanced-load instruction involves transferring data into a processor register.

10. A data processor comprising:
an instruction handler for receiving program instructions having a program order; said program instructions including an advanced load instruction and a corresponding check instruction; and
an execution unit for executing said advanced-load instruction in advance of its program order.

11. A data processor as recited in claim 10 further comprising a data register to which data is written when said execution unit executes said advanced-load instruction.
